(19) United States
(12) Patent Application Publication
(10) Pub. No.: US 2019/0272988 A1
(43) Pub. Date: Sep. 5, 2019

(54) ION TRANSPORT DEVICE AND ION MOBILITY SPECTROMETER

(71) Applicant: SHIMADZU CORPORATION, Kyoto-shi (JP)

(72) Inventors: Yuji Morihisa, Kyoto-shi (JP); Akiko Imazu, Kyoto-shi (JP)

(73) Assignee: SHIMADZU CORPORATION, Kyoto-shi (JP)

(21) Appl. No.: 16/288,299

(22) Filed: Feb. 28, 2019

(30) Foreign Application Priority Data
Mar. 1, 2018 (JP) 2018-036295

(51) Int. Cl. H01J 49/06; G01N 27/62

(52) U.S. Cl. CPC H01J 49/062; G01N 27/622

(57) ABSTRACT

Annular members having an aluminum base body coated with an insulation film formed by hard alumite processing are used as spacers (42A) alternately arrayed with flat-ring-shaped electrodes (41) along an axis (C). The insulation film provides electrical insulation between the electrodes (41) neighboring each other. This film is omitted on one side of the spacer (42A) so that the base body of this spacer is in contact with and electrically connected to one of the two electrodes (41) between which the spacer (42A) is sandwiched. Voltages applied to the electrodes (41) give specific potentials to the spacers (42A), thereby enabling the spacers (42A) to serve as a shield electrode which reduces the influence of an external electric field on an electric field within a drift unit (4). The use of such spacers decreases the cost of an ion transport device used for a drift region in an ion mobility spectrometer.

### TECHNICAL FIELD

The present invention relates to an ion transport device for transporting ions of sample-component origin by using an electric field, as well as an ion mobility spectrometer employing such an ion transport device.

### BACKGROUND ART

When a molecular ion generated from a sample molecule is made to move through a gaseous (or liquid) medium by an effect of an electric field, the ion moves at a constant speed depending on its mobility which is determined by the strength of the electric field, size of the molecule and other factors. Ion mobility spectrophotometry (IMS) is a measurement technique which utilizes this mobility for an analysis of sample molecules. Typically, IMS is used in a device which separates various sample-derived ions from each other according to their ion mobilities and subsequently detects those ions with a detector to create an ion mobility spectrum. Such a device is often used in combination with a mass analyzer.

An ion mobility spectrometer normally includes a drift tube within which a large number of flat-ring-shaped electrodes having the same shape are arrayed along a central axis. Ions derived from sample components are released in a pulsed form and sent into the inner space of this drift tube. A direct electric field having a constant potential gradient along the central axis is created within the inner space of the drift tube by the voltages respectively applied to the flat-ring-shaped electrodes. Due to this electric field, the ions are accelerated and made to drift in the axial direction. Meanwhile, a stream of drift gas flowing at a constant speed in the counter direction to the drifting ions is formed within the inner space of the drift tube. The ions travel forward while colliding with this drift gas. Consequently, the moving speed (drift speed) of each ion in the axial direction converges to a constant speed depending on its ion mobility, and the ions are separated from each other in their direction of travel according to their mobilities.

The flat-ring-shaped electrodes for creating the accelerating electric field are normally made of corrosion-resistant metal, such as stainless steel (SUS). In order to create a satisfactory electric field that can make ions drift in an appropriate way, a large number of flat-ring-shaped electrodes must be accurately arranged so that they are located at predetermined intervals in the axial direction as well as coaxially with each other. Accordingly, in many cases, conventional and common types of ion mobility spectrometers have a configuration in which a drift unit is constructed by alternately stacking ring-shaped insulation spacers having a predetermined thickness and flat-ring-shaped electrodes. Spacers made of a ceramic material, such as alumina, are often used for this purpose (for example, see Patent Literature 1).

In general, the use of ceramic parts allows for the cost reduction if those parts are mass-produced. However, ceramic parts will be expensive if they are produced in small quantities, as in the case of analytical devices. Another problem is that ceramic materials are brittle. Ceramic spacers easily fracture in the process of creating a structure in which ceramic spacers and electrodes are alternately stacked.

To address such problems, the use of a spacer made of synthetic resin, such as polyether ether ketone (PEEK), has been attempted for some types of devices. However, when used in the drift unit of an ion mobility spectrometer, PEEK may be insufficiently resistant to heat since the drift unit is heated to high temperatures (e.g. approximately 150° C. or higher). The use of highly heat-resistant synthetic resin, such as polyimide resin, is also thinkable. However, the gas which results from the pyrolysis and volatilization of the synthetic resin may become contaminations for the analysis.

### CITATION LIST

### Patent Literature

Patent Literature 1: JP 2005-276837 A

### Non Patent Literature

Non-Patent Literature 1: “Mekki Gijutsu Repooto—Koushitsu Arumaito Kakou Shori: Koushitu Arumaito Himaku No Tai-den-atsu Sokutei No Deeta (Plating Technology Report—Hard Alumite Processing Treatment: Measurement Data on Withstand Voltage of Hard Alumite Film)”, [online], Sanwa Plating Industry Incorporated Company, [accessed on Jul. 18, 2017], the Internet

### SUMMARY OF INVENTION

### Technical Problem

The present invention has been developed to solve the previously described problem. Its primary objective is to reduce the cost of an ion transport device having a configuration in which a plurality of flat electrodes are arrayed at predetermined intervals of space along an axis.

### Solution to Problem

An ion transport device according to the present invention developed for solving the previously described problem is an ion transport device including a plurality of annular electrodes arrayed along an axis to create an ion-transporting electric field within a space surrounded by the annular electrodes by respectively applying voltages to the annular electrodes, the ion transport device including:

a) a plurality of electrodes having a flat annular shape and arrayed along an axis; and

b) a plurality of spacers for defining the interval of two electrodes neighboring each other among the plurality of electrodes while securing electrical insulation between the two electrodes, each of the spacers including a base body made of metal and an insulation film made of an oxide of the metal forming the base body, with the insulation film formed at least on a portion of the surface of the base body at which the base body is in contact with one of the electrodes or one of the spacers and at which electrical insulation is required.

The ion transport device according to the present invention is typically employed in an ion mobility spectrometer or mass spectrometer used for analyzing ions. For example, the device can be used as an ion guide for transporting ions to a subsequent stage in an ion mobility spectrometer or mass spectrometer, as a drift unit in an ion mobility spectrometer, or as an ion reflector in a tome-of-flight mass spectrometer.

In the ion transport device according to the present invention, a metallic base body made coated with an insulation film which is an oxide of the metal forming the base body is used as the insulation spacer that determines the distance between two electrodes neighboring each other in the axial direction. That is to say, the base body of the spacer is an electric conductor, and the electrical insulation between the spacers or between one spacer and one electrode is secured by the oxide film formed on the surface of the base body by a predetermined treatment (processing).

The kind of metal used for the base body is not specifically limited, although there are conditions that should preferably be satisfied; e.g. the metal should be inexpensive, highly tough (not brittle), highly workable, and as light in weight as possible. One example of the material that satisfies those conditions is aluminum. In that case, the insulation film can be formed by anodic oxidation coatings on aluminum (which may also be called the “alumite processing”). A method generally called the “hard alumite processing” may preferably be used. By this technique, a thicker and harder insulation film can be formed than by normal alumite processing.

A spacer made of an aluminum base body coated with an insulation film formed by hard alumite processing has a sufficient level of resistance to a potential difference of equal to or greater than hundreds of volts. Its production cost is lower than that of the conventionally and commonly used ceramic spacers. In particular, a considerable cost reduction can be achieved in the case of a low-quantity production. Thus, the ion transport device according to the present invention can be produced at a lower cost than conventional devices which employ ceramic spacers. Furthermore, the spacer made of an aluminum base body coated with an insulation film is highly tough and will not easily fracture even if it is impacted in a manufacturing process, such as the production of a stacked structure of the spacers and electrodes. Therefore, the production efficiency of the device will be improved, and the production yield will be increased.

There are various possible modes for the ion transport device according to the present invention.

As a first mode of the present invention, the ion transport device may preferably be configured as follows: one of the electrodes is held between two of the spacers; and each of the spacers has the insulation film formed at a portion which is in contact with one of the two electrodes which are located on both sides of the spacer, while the metal forming the base body of the spacer is exposed at a portion which is in contact with the other one of the two electrodes.

If the spacer consists of a simple insulator, such as a ceramic part, there is effectively no potential within the gap between the electrodes neighboring each other in the axial direction, which means that an external electric field can enter the space surrounded by the electrodes and disturb the electric field within the space. By comparison, in the first mode of the configuration, the exposed portion of the base body (i.e. metal) in the spacer is electrically connected to one of the electrodes, so that both the electrode and the base body of the spacer have the same potential. Therefore, provided that the spacer is shaped like an annular body which entirely surrounds the axis, the structure formed by stacking the spacers will function as a type of shield electrode which blocks an external electric field or electromagnetic waves. Thus, the electric field created within the space surrounded by the electrodes is prevented from being disturbed.

As a second mode of the present invention, the ion transport device may be configured as follows: each of the spacers is a substantially annular body having an inner circumferential surface facing the axis; the metal forming the base body is exposed on the inner circumferential surface; and the electrode is fitted in the space surrounded by the inner circumferential surface of the spacer.

Unlike the first mode of the ion transport device in which the electrode is held by being sandwiched between two spacers, the electrode in the second mode of the ion transport device is held by being fitted in the space surrounded by the inner circumferential surface of a spacer having a substantially annular shape. Accordingly, an electrode unit of the ion transport device can be easily assembled by stacking an appropriate number of spacers each of which has an electrode previously fitted into it.

As a third mode of the present invention, the ion transport device may be configured as follows: the base body of each of the spacers has a substantially annular body having a predetermined thickness in the axial direction, with a flat annular portion protruding from an inner circumferential surface of the annular body; and the metal forming the base body is exposed at the flat annular portion to make the flat annular portion function as one of the electrodes.

Unlike the first and second modes of the ion transport device in which the spacer and the electrode are separate members, the spacer and the electrode in the third mode of the ion transport device are formed as a single member. Such a configuration even further facilitates the assembling work.

Any of the first through third modes of the ion transport device may additionally be configured as follows: two of the spacers neighboring each other in the axial direction have a concave portion and a convex portion respectively formed on two surfaces facing each other of the two spacers, with the convex portion being configured to be fitted into the concave portion; and the concave portion and the convex portion are configured so as to allow a plurality of spacers to be arrayed in a stacked form along the axial direction with the convex portion of one spacer fitted in the concave portion of another spacer.

According to this configuration, the positioning of the spacers can be achieved by fitting the convex portion of one spacer into the concave portion of another spacer, whereby a plurality of spacers (and electrodes) can be accurately arrayed along a linear axis. Since the base body used for the spacer in the present invention is made of metal and highly workable, it is easier to create the convex portion, concave portion and other necessary forms in the base body than in the case of the conventional spacer made of a ceramic material which is brittle and insufficiently workable.

In the previously described configuration, a screw hole may be formed in each of the spacers so as to allow two or more of the spacers to be combined with each other by a screw inserted through the screw holes of the spacers neighboring each other in the axial direction. Alternatively, each of the spacers may have one threaded portion formed on the convex portion and another threaded portion formed on the concave portion so as to allow the convex portion and the concave portion to be screwed together.

Such configurations allow neighboring spacers to be screwed together and combined into one unit, without requiring additional members for combining the spacers and electrodes into one unit. Those configurations are also advantageous for downsizing the electrode unit of the ion transport device.

The ion transport device according to the present invention may preferably include an electrically conductive rod part having one end embedded in the base body of each of the spacers to allow for an application of a voltage to the base body through the rod part.

As a specific example, the electrically conductive rod part may be fitted into an appropriate hole bored in the base body. In the configuration in which the base body of the spacer is electrically connected to the electrode, when a voltage is applied to the rod part, the voltage is also applied to the electrode via the base body. Therefore, the lead wire for applying the voltage to the electrode does not need to be directly connected to the electrode. This simplifies the wiring of the lines for individually applying voltages to the electrodes.

As noted earlier, the ion transport device according to the present invention is suitable for use in an ion mobility spectrometer, mass spectrometer or similar type of device. In particular, the present invention is suitable for forming a drift region within which ions in a pulsed form are made to drift.

Normally, in an ion mobility spectrometer, a stream of drift gas is formed within the drift region in the counter direction to the ions which travel due to an accelerating electric field. If each spacer is shaped like an annular body which entirely surrounds the axis, the drift gas can smoothly flow within the drift region without leaking to the surrounding area. Furthermore, since the electrodes are spaced at highly accurate intervals, an accelerating electric field having an almost ideal potential gradient can be created. Accordingly, ions can be separated from each other with high accuracy according to their ion mobilities.

### Advantageous Effects of Invention

According to the present invention, it is possible to decrease the cost of the spacers used for defining the intervals of the electrodes in an ion transport device (or ion mobility spectrometer) while securing electrical insulation and other performances of the device. This contributes to a cost reduction of the entire device. Additionally, the spacers used in the present invention do not easily fracture and can be easily assembled.

### BRIEF DESCRIPTION OF DRAWINGS

FIG. 1 is a schematic configuration diagram of an ion mobility spectrometer using an ion transport device as the first embodiment of the present invention.

FIG. 2 is a schematic configuration diagram of an ion mobility spectrometer using an ion transport device as the second embodiment of the present invention.

FIG. 3 is a sectional view of one flat-ring-shaped electrode and one spacer in the ion transport device according to the first embodiment.

FIG. 4 is a sectional view of one flat-ring-shaped electrode and one spacer in the ion transport device according to the second embodiment.

FIG. 5 is a schematic configuration diagram showing the main section of an ion transport device as the third embodiment of the present invention.

FIG. 6 is a sectional view of one flat-ring-shaped electrode and one spacer in the ion transport device according to the third embodiment.

FIG. 7 is a schematic configuration diagram showing the main section of an ion transport device as the fourth embodiment of the present invention.

FIG. 8 is a sectional view of one flat-ring-shaped electrode and one spacer in the ion transport device according to the fourth embodiment.

FIG. 9 is a schematic configuration diagram showing the main section of an ion transport device as the fifth embodiment of the present invention.

FIG. 10 is a sectional view of one flat-ring-shaped electrode and one spacer in the ion transport device according to the fifth embodiment.

FIG. 11 is a schematic configuration diagram showing the main section of an ion transport device as the sixth embodiment of the present invention.

FIG. 12 is a sectional view of one flat-ring-shaped electrode and one spacer in the ion transport device according to the sixth embodiment.

FIG. 13 is a schematic configuration diagram showing the main section of an ion transport device as the seventh embodiment of the present invention.

FIG. 14 is a sectional view of a spacer-integrated flat-ring-shaped electrode in the ion transport device according to the seventh embodiment.

### DESCRIPTION OF EMBODIMENTS

Embodiments of the ion transport device according to the present invention as well as ion mobility spectrometers using the ion transport devices according to the embodiments are hereinafter described with reference to the attached drawings.

### First Embodiment

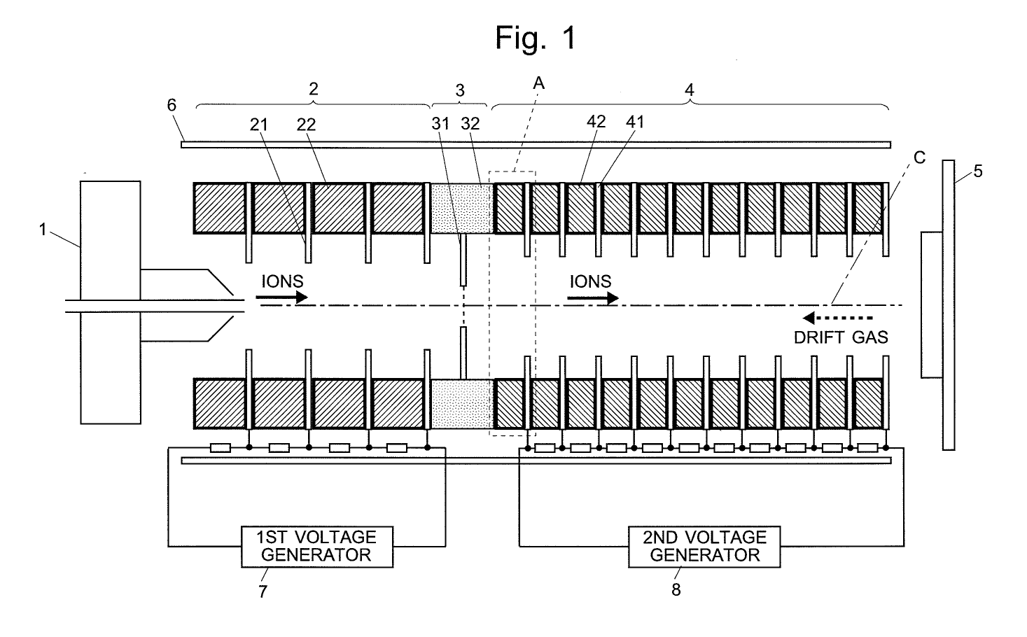

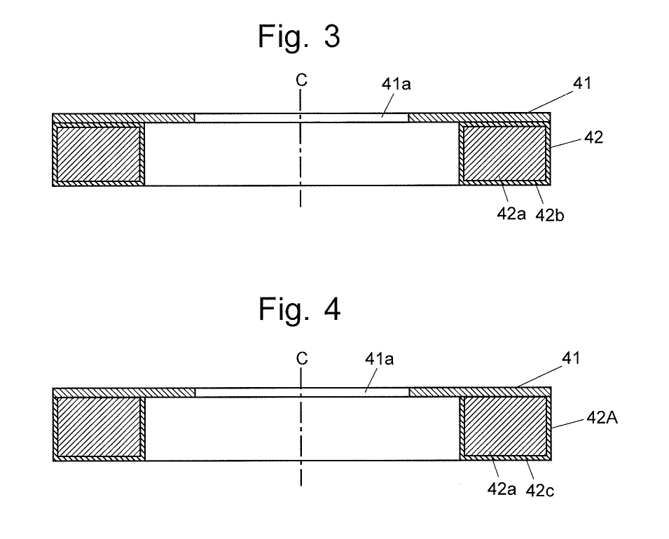

FIG. 1 is a schematic configuration diagram of an ion mobility spectrometer using an ion transport device as the first embodiment of the present invention. FIG. 3 is a sectional view of one flat-ring-shaped electrode and one spacer (the portion indicated by reference sign A in FIG. 1) in the ion transport device according to the first embodiment. It should be note that the electrodes and the spacers in FIG. 1 are shown by an end view in order to prevent the drawing from being complex, whereas the electrode and the spacer in FIG. 3 are shown by a sectional view. The same also applies in any of the following embodiments.

As shown in FIG. 1, the ion mobility spectrometer according to the present embodiment includes an ion source 1 for ionizing components in a liquid sample, an ionization-promoting unit 2 for promoting the ionization, a gate electrode unit 3 for temporarily blocking ions and subsequently releasing them in a pulsed form, a drift unit 4 for making ions drift, and an ion detector 5 for detecting ions.

The ion source 1 is an ion source employing an electrospray ionization (ESI) method in which ions are generated by spraying a sample solution into an ambience of substantially atmospheric pressure while electrically charging the droplets of the solution. The ionization method for the ion source 1 is not limited to this one. For example, an ion source which employs an atmospheric pressure chemical ionization (APCI) method using a vaporized sample introduction unit and a corona needle is also available.

The ionization-promoting unit 2 includes a plurality of flat-ring-shaped electrodes 21 arrayed along a linear axis C, with spacers 22 sandwiched in between. Different direct voltages are respectively applied from a first voltage generator 7 to the electrodes 21 through a resistor network. The ionization-promoting unit 2 is heated to a temperature of 100° C. to 200° C. with a heater (not shown) in order to accelerate vaporization of the solvent in the charged droplets sprayed from the ion source 1 and thereby promote the generation of the ions.

The drift unit 4 has a similar structure to the ionization-promoting unit 2 and includes a plurality of flat-ring-shaped electrodes 41 arrayed along the linear axis C, with insulation spacers 42 sandwiched in between. Different direct voltages are respectively applied from a second voltage generator 8 to the electrodes 41 through a resistor network. The space surrounded by the inner circumferential edges of the electrodes 41 is the drift region within which ions are made to drift according their respective ion mobilities. A stream of specific kind of drift gas (inert gas) at a constant speed is formed within the drift region from the exit end toward the entrance end of the drift unit 4. The gas pressure within the drift region is maintained at substantially atmospheric pressure (or at a low-vacuum state of approximately a few to several hundred Pa) by the drift gas. The configuration of this drift unit 4 will be described later in detail.

The gate electrode unit 3 is located between the ionization-promoting unit 2 and the drift unit 4. It includes a substantially cylindrical electrode holder 32 made of an insulating material and a grid electrode 31 having a large number of openings. A pulsed voltage is applied from a gate voltage generator (not shown) to the grid electrode 31 at a predetermined timing.

The ionization-promoting unit 2, gate electrode unit 3 and drift unit 4 are entirely contained within a cylindrical shield electrode 6. This structure is primarily aimed at preventing the electric field within the drift unit 4 from being disturbed due to an electric field, electromagnetic waves or other factors which are present in the surrounding area.

Now, the configuration of the electrode 41 and the spacer 42 in the drift unit 4 is described in detail. The electrode 21 and the spacer 22 in the ionization-promoting unit 2 also have almost the same configuration as the electrode 41 and the spacer 42, although no detailed description will be given to them.

As described earlier, the electrode 41 is a flat-ring-shaped conductor having a circular opening 41a of a predetermined diameter with its center located on the axis C. This electrode 41 is normally made of corrosion-resistant metal, such as stainless steel (SUS). The spacer 42, which defines the interval of two electrodes 41 neighboring each other in the axial direction, is a ring-shaped (or doughnut-shaped) body having a rectangular sectional shape whose outer diameter is approximately equal to that of the electrode 41. The base body 42a is made of metal, or more specifically, aluminum. Aluminum has the favorable characteristics that it is comparatively inexpensive, light in weight, and can be easily worked into a complex shape. This aluminum-made base body 42a is entirely coated with an insulation film 42b formed by hard alumite processing, which is a type of anodization coating treatment.

The hard alumite processing is a technique in which the coating process is slowly performed within a low-temperature electrolytic cell to form a thick, hard film. The thereby formed insulation film is harder and has higher insulation properties than common types of alumite film. For example, according to Non-Patent Literature 1, an oxide film with a thickness of 50 μm exhibits a withstand voltage of equal to or higher than 900 V between the film and the base body, or a withstand voltage of equal to or higher than 1200 V between the two films. The potential difference between the two electrodes 41 neighboring each other in the axial direction is normally a few to several hundred volts, depending on the interval of the electrodes 41 in the drift unit 4. The aforementioned withstand voltages are sufficient for such cases. Additionally, such insulation parts made of aluminum finished with hard alumite processing are normally less expensive than ceramic parts of the same shape and performance levels.

As shown in FIG. 1, the drift unit 4 in the ion transport device according to the first embodiment has a substantially cylindrical outer shape formed by the electrodes 41 and the insulation spacers 42 alternately stacked along the axis C. Each spacer 42 is shaped like a ring which entirely surrounds the axis C and is hermetically in contact with the electrodes 41 on both sides. Accordingly, as indicated by the dashed line in FIG. 1, the drift gas introduced into the drift region forms a satisfactory stream toward the entrance end without leaking to the outside.

Next, a measurement operation in the ion mobility spectrometer according to the present embodiment is schematically described.

The ion source 1 receives a liquid sample from outside and sprays the sample into the ionization-promoting unit 2 while electrically charging its droplets. During the process in which the solvent is vaporized from the fine charged droplets produced by the spraying, the sample components in the droplets turn into ions. Due to the electric field created by the voltages respectively applied to the electrodes 21 in the ionization-promoting unit 2, the ions travel toward the gate electrode unit 3. A voltage which blocks the ions is applied to the grid electrode 31. For example, if the ions are positive ions, a high level of positive voltage is applied to the grid electrode 31. Due to the potential barrier formed by this voltage, the ions are accumulated in front of the grid electrode 31. Then, a voltage for allowing the ions to pass through (i.e. a voltage at which the potential barrier disappears) is applied to the grid electrode 31 at a predetermined timing and for a short period of time, whereupon the accumulated ions pass through the grid electrode 31 in a pulsed form and enter the drift region.

The direct voltages applied to the electrodes 41 create an electric field for accelerating the ions in the axial direction within the drift region. Meanwhile, a stream of drift gas flowing in the counter direction to the travel of the ions is formed within the same region. While the ions driven by the accelerating electric field are travelling against the stream of drift gas, the ions are separated from each other according to their respective mobilities and arrive at the ion detector 5 exhibiting time differences. The ion detector 5 produces detection signals according to the amount of ions which it has received. Based on those detection signals, a data processor (not shown) can create a spectrum which shows a relationship between the drift time (which corresponds to the ion mobility) and the ion intensity.

As noted earlier, the spacer 42, i.e. the base body 42a made of aluminum with the hard-alumite insulation film 42b formed on its surface, exhibits high insulation properties and yet is inexpensive. Therefore, the ion transport device and the ion mobility spectrometer according to the present invention can be produced at lower costs than the conventional devices which use ceramic spacers. If a spacer made of synthetic resin is used, the gas resulting from the pyrolysis and volatilization of the synthetic resin heated to approximately 150° C. or higher temperatures may possibly become contaminations for the measurement. The spacer 42 in the present embodiment does not cause such a problem of contamination.

### Second Embodiment

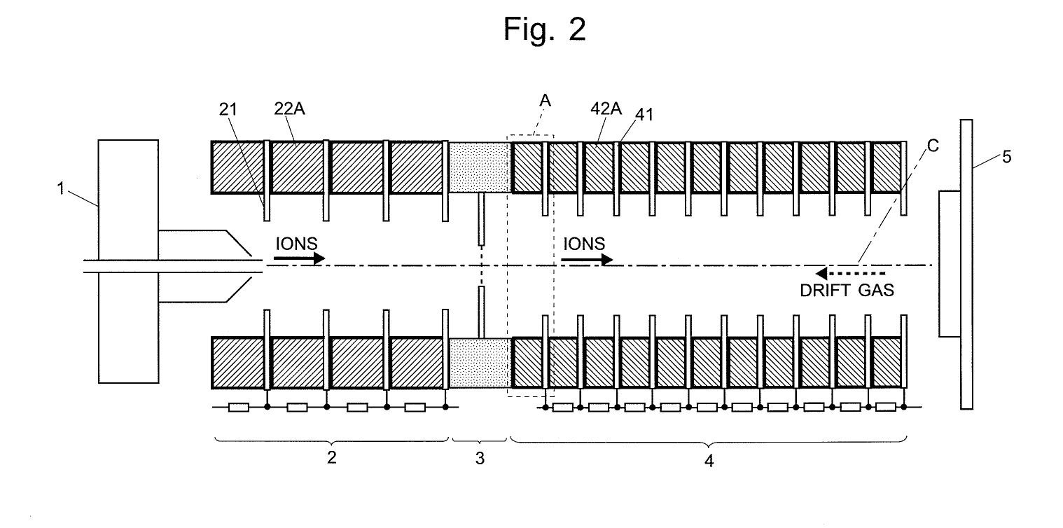

FIG. 2 is a schematic configuration diagram of an ion mobility spectrometer using an ion transport device as the second embodiment of the present invention. FIG. 4 is a sectional view of one flat-ring-shaped electrode and one spacer in the ion transport device according to the second embodiment. The same components as used in the first embodiment are denoted by the same reference signs, and detailed descriptions of those components will be omitted.

In the ion transport device according to the first embodiment, the insulation film 42b was formed on the entire surface of the base body 42a of the spacer 42. By comparison, in the ion transport device according to the second embodiment, as shown in FIG. 4, the insulation film 42c does not cover the entire surface of the base body 42a; the base body 42a is exposed on the side on which the base body 42a is in contact with one electrode 41. On the opposite side of the base body 42a, which is in contact with another electrode 41 that is adjacent to the one aforementioned electrode 41, the insulation film 42c is formed in a similar manner to the first embodiment. Therefore, in each pair of electrodes 41 having one spacer 42A sandwiched in between, one electrode 41 (on the right side in FIG. 2) is electrically connected to the base body 42a of the spacer 42A. That is to say, they can be considered as one part in terms of electricity. The other electrode 41 (on the left side in FIG. 2) is electrically insulated from the base body 42a of the spacer 42A by the insulation film 42c.

When the predetermined direct voltages are applied from the second voltage generator 8 (not shown in FIG. 2) to the respective electrodes 41 through the resistor network, the base body 42a of each spacer 42A which is in direct contact with one of the electrodes 41 has the same potential as the corresponding electrode 41. Needless to say, the spacer 42A, which is thus in direct contact with one electrode 41, is sufficiently insulated from the other electrode 41 on the opposite side by the hard-alumite insulation film 42c which is present between the spacer and the latter electrode.

In the ion transport device according to the first embodiment, none of the base bodies 42a of the spacers 42A has a potential (i.e. they are in the floating state). By comparison, in the ion transport device according to the second embodiment, all base bodies 42a of the spacers 42A respectively have predetermined potentials. Thus, the drift region is almost entirely surrounded by electric conductors having certain potentials, and the spacers 42A perform the function of the shield electrode 6 in the ion transport device according to the first embodiment. Therefore, it is unnecessary to additionally provide a shield electrode 6 as in the first embodiment. This allows for the corresponding downsizing of the drift unit 4.

### Third Embodiment

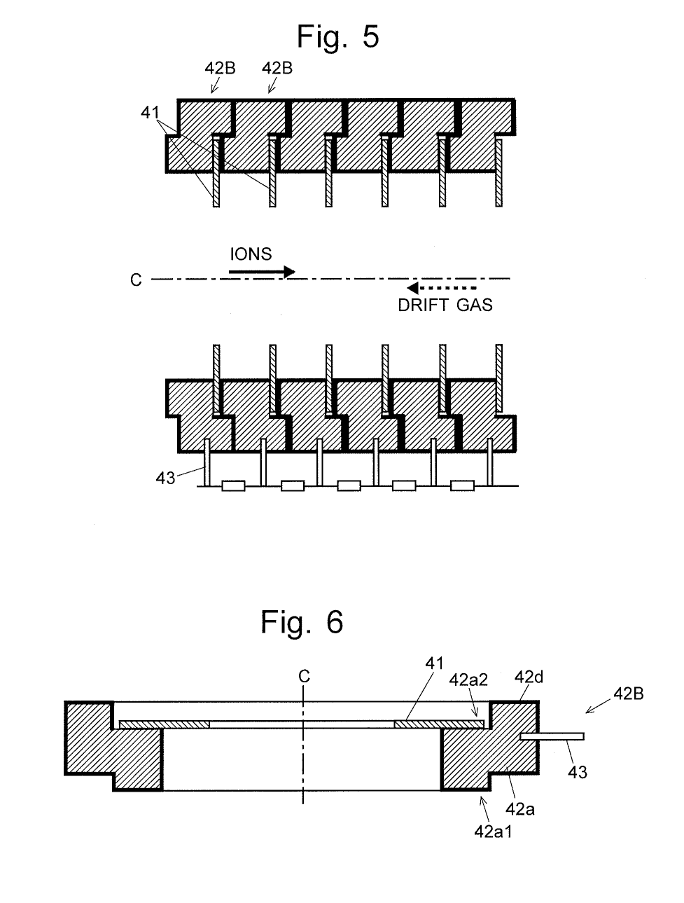

FIG. 5 is a schematic configuration diagram of an ion transport device as the third embodiment of the present invention. FIG. 6 is a sectional view of one flat-ring-shaped electrode and one spacer in the ion transport device according to the third embodiment. FIG. 5 shows the portion corresponding to the drift unit 4 in the ion mobility spectrometer as shown in FIG. 1 or 2. The same components as used in the previous embodiments are denoted by the same reference signs, and detailed descriptions of those components will be omitted.

Similar to the second embodiment, the insulation film 42d is not formed on the surface of the base body 42a at the portion where the spacer 42B is in contact with one electrode 41; the base body 42a is in direct contact with the electrode 41 at this portion. By comparison, the insulation film 42d is formed at the portion where the spacer 42B is in contact with another electrode 41 adjacent to the one aforementioned electrode 41, thereby securing electrical insulation between the spacer 42B and the electrode 41. The sectional shape of the base body 42a of the spacer 42B is not a simple rectangle. A ring-shaped concave portion 42a2 for receiving the electrode 41 in direct contact with the base body 42a is formed on one side of the base body 42a. while a ring-shaped convex portion 42a1 to be fitted into the concave portion 42a2 of a neighboring spacer 42B is formed on the other side which is in contact with another electrode 41 via the insulation film 42d. On the outer circumferential surface of the spacer 42B, a metallic terminal rod 43 is fitted in a hole bored in the base body 42a, piercing through the insulation film 42d (or passing through an area where no insulation film 42d is present).

In the ion transport device according to the third embodiment, one electrode 41 is held between two spacers 42B by fitting the convex portion 42a1 of one spacer 42B into the concave portion 42a2 of the other spacer 42B. As shown in FIG. 5, the drift unit 4 having a substantially cylindrical shape can be formed by stacking a plurality of spacers 42B one after another with the convex portion 42a1 fitted in the concave portion 42a2. According to this configuration, the position of each spacer 42B and that of each electrode 41 are determined by the fitting of the spacers 42B. Therefore, the central axis of the electrodes 41 can be easily aligned on the same straight line, and the assembling work can be easily and accurately performed. Application of a voltage to each electrode 41 can be achieved by applying the voltage to the terminal rod 43 projecting from the corresponding spacer 42B. Accordingly, it is unnecessary to directly connect the lead wire for voltage application to the electrode 41. This simplifies the wiring system for voltage application.

### Fourth Embodiment

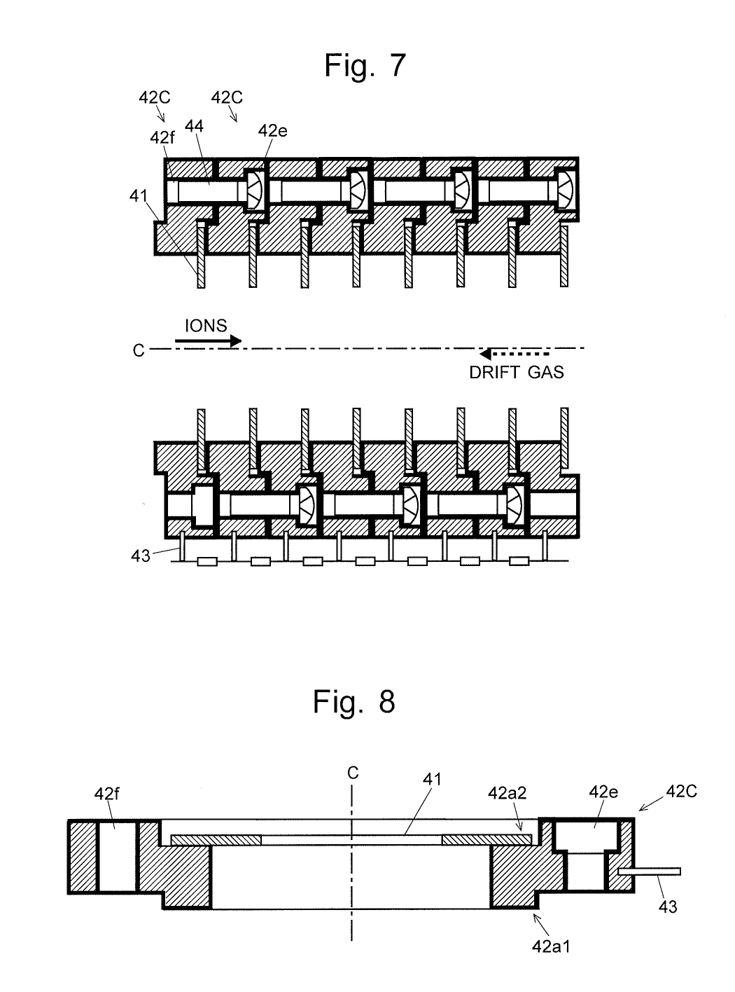

FIG. 7 is a schematic configuration diagram of an ion transport device as the fourth embodiment of the present invention. FIG. 8 is a sectional view of one flat-ring-shaped electrode and one spacer in the ion transport device according to the fourth embodiment. FIG. 7 shows the portion corresponding to the drift unit 4 in the ion mobility spectrometer as shown in FIG. 1 or 2. The same components as used in the previous embodiments are denoted by the same reference signs, and detailed descriptions of those components will be omitted.

The basic form of the spacer 42C in the ion transport device according to the fourth embodiment is the same as that of the spacer 42B in the ion transport device according to the third embodiment. A difference exists in that the present spacer 42C has two screw holes 42e and 42f for screwing two neighboring spacers 42C together. One screw hole 42e formed in one spacer 42C is a through hole having a recess for receiving the head of the screw 44. The other screw hole 42f formed in the neighboring spacer 42C is a threaded through hole which the screw portion of the screw 44 is to be screwed into. Each spacer 42C has at least one screw hole 42e and at least one screw hole 42f (preferably, a plurality of screw holes 42e and a plurality of screw holes 42f). The inner surface of each of the screw holes 42e and 42f is covered with a hard-alumite insulation film 42d which is a continuation of the insulation film 42d covering the outer surface of the base body 42a.

In the process of stacking a plurality of spacers 42C one after another as shown in FIG. 7, a screw 44 is inserted through the screw hole 42e of one spacer 42C, and the screw portion of this screw 44 is screwed into the screw hole 42f of the neighboring spacer 42C to combine the two spacers 42C. As noted earlier, the inner surfaces of the screw holes 42e and 42f are coated with the insulation film 42d. Therefore, the electrical insulation between the base bodies 42a of the two spacers 42C can be secured even if a metallic screw 44 is used. Such a use of the screws for combining a plurality of spacers 42C into one unit eliminates the necessity of additional members for holding the spacers 42C and the electrodes 41 as one unit. This is advantageous for the downsizing of the device.

### Fifth Embodiment

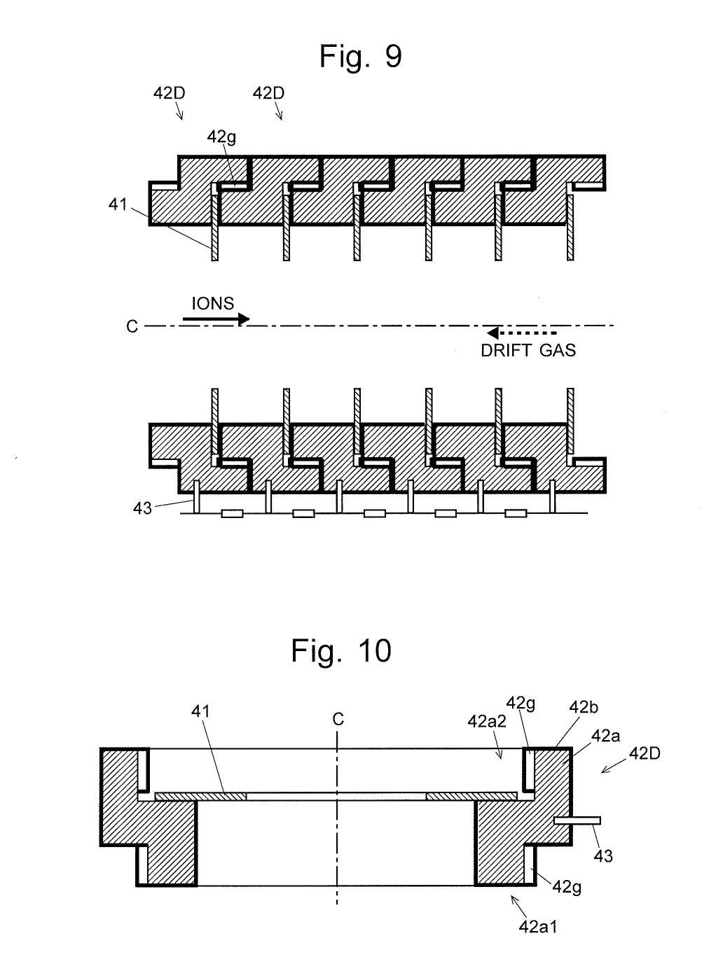

FIG. 9 is a schematic configuration diagram of an ion transport device as the fifth embodiment of the present invention. FIG. 10 is a sectional view of one flat-ring-shaped electrode and one spacer in the ion transport device according to the fifth embodiment. FIG. 9 shows the portion corresponding to the drift unit 4 in the ion mobility spectrometer as shown in FIG. 1 or 2. The same components as used in the previous embodiments are denoted by the same reference signs, and detailed descriptions of those components will be omitted.

The basic form of the spacer 42D in the ion transport device according to the fifth embodiment is also the same as that of the spacer 42B in the ion transport device according to the third embodiment. A difference of the present spacer 42D from the third embodiment exists in that screw portions (thread ridge and thread groove) 42g for fixing two neighboring spacers 42D to each other without using additional members are formed on the outer cylindrical surface of the convex portion 42a1 and the inner cylindrical surface of the concave portion 42a2, respectively. Those screw portions 42g have insulation films 42d formed on their surfaces by hard alumite processing. When the convex portion 42a1 of one spacer 42D is to be fitted into the concave portion 42a2 of another spacer 42D, the screw portions 42g of the two spacers are screwed together. Thus, the two spacers 42D, with the electrode 41 located in between, can be screwed together without using screws or similar additional parts.

### Sixth Embodiment

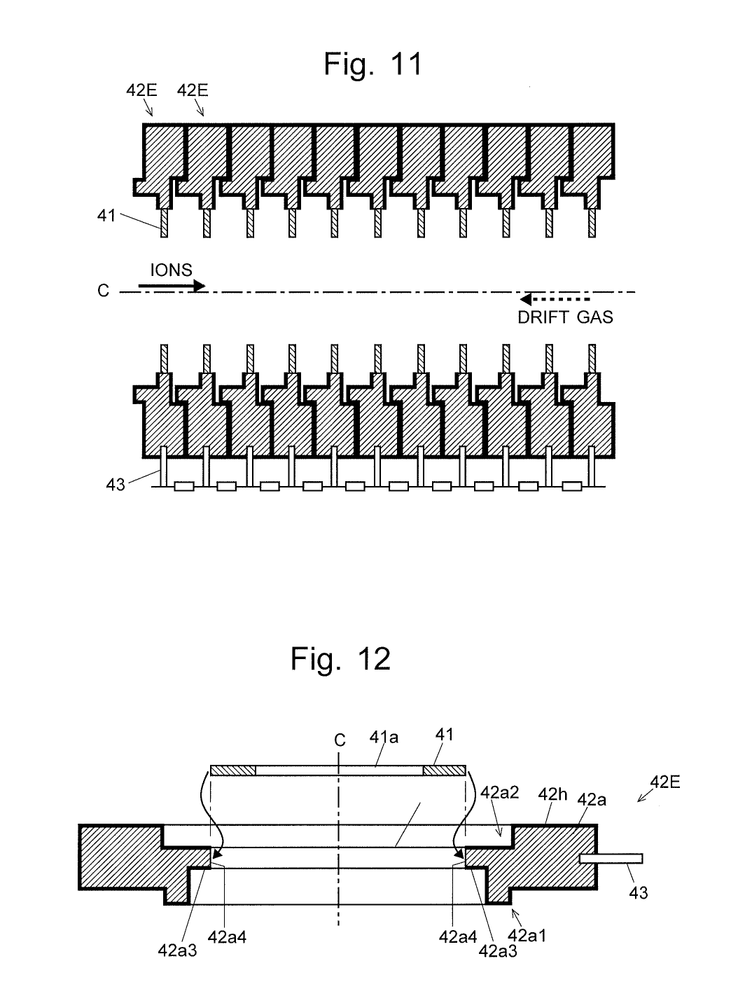

FIG. 11 is a schematic configuration diagram of an ion transport device as the sixth embodiment of the present invention. FIG. 12 is a sectional view of one flat-ring-shaped electrode and one spacer in the ion transport device according to the sixth embodiment. FIG. 11 shows the portion corresponding to the drift unit 4 in the ion mobility spectrometer as shown in FIG. 1 or 2. The same components as used in the previous embodiments are denoted by the same reference signs, and detailed descriptions of those components will be omitted.

In the ion transport device according to any of the first through fifth embodiments, the electrode 41 is held between two neighboring spacers. In the ion transport device according to the sixth embodiment, the electrode 41 is held in a different manner: The spacer 42E has a ring-shaped electrode-holding portion 42a3 which radially protrudes toward the axis. This electrode-holding portion 42a3 has an inner circumferential surface (flattened cylindrical surface) 42a4 facing the axis, on which no insulation film is formed, and the base body 42a is exposed. The outer diameter of the flat-ring-shaped electrode 41 is made to be slightly larger than the inner diameter of the flattened cylindrical surface 42a4 so that the electrode 41 can be fitted into and securely held by this flattened cylindrical surface 42a4. In this state, since the base body 42a of the spacer 42E is in direct contact with the electrode 41, the voltage applied to each spacer 42E through the terminal rod 43 is also applied to the corresponding electrode 41.

One or more shallow grooves for fitting the electrode 41 into the spacer 42E may be formed on the flattened cylindrical surface 42a4. The flattened cylindrical surface 42a4 of the spacer 42E may be a tapered surface which is not parallel to the axis but is inclined to the axis to facilitate the fitting of the electrode 41.

### Seventh Embodiment

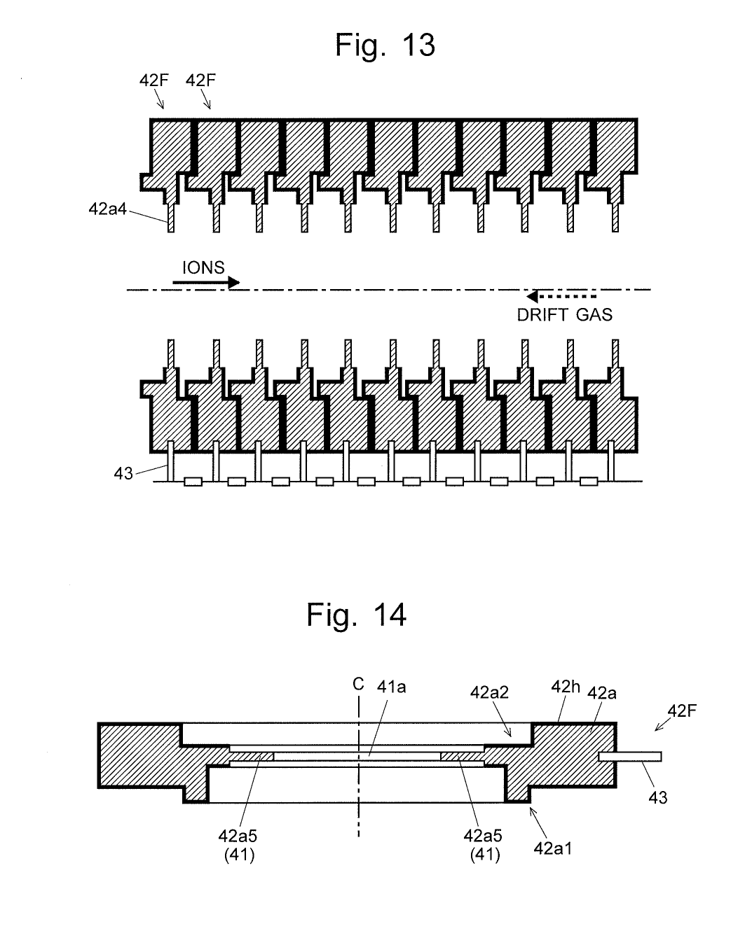

FIG. 13 is a schematic configuration diagram of an ion transport device as the seventh embodiment of the present invention. FIG. 14 is a sectional view of one flat-ring-shaped electrode and one spacer in the ion transport device according to the seventh embodiment. FIG. 13 shows the portion corresponding to the drift unit 4 in the ion mobility spectrometer as shown in FIG. 1 or 2. The same components as used in the previous embodiments are denoted by the same reference signs, and detailed descriptions of those components will be omitted.

Unlike the ion transport device according to any of the first through sixth embodiments in which the spacer 42 (42A, . . . ) and the electrode 41 are separate parts, the spacer and the electrode in the seventh embodiment are integrally formed as one part.

The base body 42a of a spacer-integrated flat-ring-shaped electrode 42F in the present ion transport device has a similar cross-sectional shape to the spacer 42E in the sixth ion transport device. A difference exists in that the base body 42a has a flat-electrode portion 42a5 which radially protrudes toward the axis. The insulation film 42h is not formed on the surface of this flat-electrode portion 42a5, whereas the surface of the base body 42a exclusive of the flat-electrode portion 42a5 is entirely coated with the insulation film 42h. This plate-electrode portion 42a5 corresponds to the electrode 41 in the ion transport device according to the sixth embodiment.

It should be noted that the flat-electrode portion 42a5 in the ion transport device according to this seventh embodiment is made of the same metal as the base body 42a, i.e. aluminum. Therefore, if the device is used in an ambience of nearly atmospheric pressure, the electrode portion may be gradually oxidized on its surface and eventually be incapable of creating an appropriate electric field. Therefore, the ion transport device according to the seventh embodiment should preferably be used in a vacuum atmosphere rather than under atmospheric pressure.

Any of the previous embodiments is an example in which an ion transport device according to the present invention is applied in a drift unit 4 or ionization-promoting unit 2 in an ion mobility spectrometer. However, the ion transport device according to the present invention can generally be used as an ion optical element for creating an electric field having a predetermined potential gradient or potential distribution along an axial direction. For example, it can be used as an ion guide for transporting ions to a subsequent stage in a mass spectrometer. It can also be used as a reflector for creating an electric field which reflects ions in a reflectron time-of-flight mass spectrometer.

In the case of using the present invention for the drift region in an ion mobility spectrometer in the previously described manner, the spacers should preferably have a ring-like shape. By comparison, if the ion transport device is used in a vacuum atmosphere as in the case of the reflector in a reflectron time-of-flight mass spectrometer, it is preferable to form an appropriate opening in the spacers to maintain the degree of vacuum within the space surrounded by the electrodes and the spacers.

The previous embodiments are mere examples of the present invention, and any change, modification or addition appropriately made within the spirit of the present invention in any aspects other than those described in the previous embodiments will naturally fall within the scope of claims of the present application.

### REFERENCE SIGNS LIST

1 . . . Ion Source
2 . . . Ionization-Promoting Unit
21 . . . Electrode
22 . . . Spacer
3 . . . Gate Electrode Unit
31 . . . Grid Electrode
32 . . . Electrode Holder
4 . . . Drift Unit
41 . . . Electrode
41a . . . Circular Opening
42, 42A, 42B, 42C, 42D, 42E . . . Spacer
42f . . . Spacer-Integrated Flat-Ring-Shaped Electrode
42a . . . Base Body
42a1 . . . Convex Portion
42a2 . . . Concave Portion
42a3 . . . Electrode-Holding Portion
42a4 . . . Flattened Cylindrical Surface
42a5 . . . Flat-Electrode Portion
42b, 42c, 42d, 42h . . . Insulation Film
42e, 42f . . . Screw Hole
42g . . . Screw Portion
43 . . . Terminal Rod
44 . . . Screw
5 . . . Ion Detector
6 . . . Shield Electrode
7 . . . First Voltage Generator
8 . . . Second Voltage Generator

1. An ion transport device including a plurality of annular electrodes arrayed along an axis to create an ion-transporting electric field within a space surrounded by the annular electrodes by respectively applying voltages to the annular electrodes, the ion transport device comprising:
a) a plurality of electrodes having a flat annular shape and arrayed along an axis; and
b) a plurality of spacers for defining an interval of two electrodes neighboring each other among the plurality of electrodes while securing electrical insulation between the two electrodes, each of the spacers including a base body made of metal and an insulation film made of an oxide of the metal forming the base body, with the insulation film formed at least on a portion of a surface of the base body at which the base body is in contact with one of the electrodes or one of the spacers and at which electrical insulation is required.

2. The ion transport device according to claim 1, wherein:
one of the electrodes is held between two of the spacers; and
each of the spacers has the insulation film formed at a portion which is in contact with one of the two electrodes which are located on both sides of the spacer, while the metal forming the base body of the spacer is exposed at a portion which is in contact with the other one of the two electrodes.

3. The ion transport device according to claim 1, wherein:
each of the spacers is a substantially annular body having an inner circumferential surface facing the axis;
the metal forming the base body is exposed on the inner circumferential surface; and
the electrode is fitted in a space surrounded by the inner circumferential surface of the spacer.

4. The ion transport device according to claim 1, wherein:
the base body of each of the spacers has a substantially annular body having a predetermined thickness in the axial direction, with a flat annular portion protruding from an inner circumferential surface of the annular body; and
the metal forming the base body is exposed at the flat annular portion to make the flat annular portion function as one of the electrodes.

5. The ion transport device according to claim 2, wherein:
two of the spacers neighboring each other in the axial direction have a concave portion and a convex portion respectively formed on two surfaces facing each other of the two spacers, with the convex portion being configured to be fitted into the concave portion; and
the concave portion and the convex portion are configured so as to allow a plurality of spacers to be arrayed in a stacked form along the axial direction with the convex portion of one spacer fitted in the concave portion of another spacer.

6. The ion transport device according to claim 5, wherein:
a screw hole is formed in each of the spacers so as to allow two or more of the spacers to be combined with each other by a screw inserted through the screw holes of the spacers neighboring each other in the axial direction.

7. The ion transport device according to claim 5, wherein:
each of the spacers has one threaded portion formed on the convex portion and another threaded portion formed on the concave portion so as to allow the convex portion and the concave portion to be screwed together.

8. The ion transport device according to claim 2, further comprising:
an electrically conductive rod part having one end embedded in the base body of each of the spacers to allow for an application of a voltage to the base body through the rod part.

9. The ion transport device according to claim 1, wherein:
the base body is made of aluminum; and
the insulating film is an oxide film formed by hard alumite processing.

10. An ion mobility spectrometer, wherein:
the ion transport device according to claim 1 is used for forming a drift region within which ions in a pulsed form are made to drift.

11. The ion transport device according to claim 3, wherein:
two of the spacers neighboring each other in the axial direction have a concave portion and a convex portion respectively formed on two surfaces facing each other of the two spacers, with the convex portion being configured to be fitted into the concave portion; and
the concave portion and the convex portion are configured so as to allow a plurality of spacers to be arrayed in a stacked form along the axial direction with the convex portion of one spacer fitted in the concave portion of another spacer.

12. The ion transport device according to claim 4, wherein:
two of the spacers neighboring each other in the axial direction have a concave portion and a convex portion respectively formed on two surfaces facing each other of the two spacers, with the convex portion being configured to be fitted into the concave portion; and
the concave portion and the convex portion are configured so as to allow a plurality of spacers to be arrayed in a stacked form along the axial direction with the convex portion of one spacer fitted in the concave portion of another spacer.

13. The ion transport device according to claim 11, wherein:
a screw hole is formed in each of the spacers so as to allow two or more of the spacers to be combined with each other by a screw inserted through the screw holes of the spacers neighboring each other in the axial direction.

14. The ion transport device according to claim 11, wherein:
each of the spacers has one threaded portion formed on the convex portion and another threaded portion formed on the concave portion so as to allow the convex portion and the concave portion to be screwed together.

15. The ion transport device according to claim 12, wherein:
a screw hole is formed in each of the spacers so as to allow two or more of the spacers to be combined with each other by a screw inserted through the screw holes of the spacers neighboring each other in the axial direction.

16. The ion transport device according to claim 12, wherein:
each of the spacers has one threaded portion formed on the convex portion and another threaded portion formed on the concave portion so as to allow the convex portion and the concave portion to be screwed together.

17. The ion transport device according to claim 3, further comprising:
an electrically conductive rod part having one end embedded in the base body of each of the spacers to allow for an application of a voltage to the base body through the rod part.

18. The ion transport device according to claim 4, further comprising:
an electrically conductive rod part having one end embedded in the base body of each of the spacers to allow for an application of a voltage to the base body through the rod part.
